(19) United States
(12) Patent Application Publication
(10) Pub. No.: US 2025/0044139 A1
(43) Pub. Date: Feb. 6, 2025

(54) MULTIPLE RADAR TRANSMITTER LIQUID LEVEL SENSOR SYSTEMS AND METHODS FOR MOBILE, LOW PROFILE STORAGE TANKS

(71) Applicant: AlphaHive LLC, Springville, UT (US)

(72) Inventors: Michael A. Jensen, Springville, UT (US); Thomas William Karlinsey, American Fork, UT (US); Daniel Arnaudov Sharp, Saratoga Springs, UT (US)

(21) Appl. No.: 18/643,513

(22) Filed: Apr. 23, 2024

Related U.S. Application Data
(60) Provisional application No. 63/517,177, filed on Aug. 2, 2023.

(51) Int. Cl. G01F 23/284; G01F 23/80

(52) U.S. Cl. CPC G01F 23/284; G01F 23/802

(57) ABSTRACT

Liquid level sensor systems and methods include a sensor having a plurality of radar transmitters, one or more radar receivers, and antennas associated with each of the plurality of radar transmitters at respectively unique locations relative to the liquid storage tank. A processor is configured to determine, in view of the respective radar returns from combinations of the plurality of radar transmitters and one or more radar receivers, a single liquid level output for the liquid storage tank in order to reduce an influence of possibly inaccurate radar returns due to localized effects from tank imperfections and/or solid/liquid buildup.

### CROSS REFERENCE TO RELATED APPLICATIONS

This application claims the benefit of U.S. Provisional Application Ser. No. 63/517,177 filed Aug. 2, 2023, the entire disclosure of which is hereby incorporated by reference in its entirety.

### BACKGROUND OF THE INVENTION

The field of the invention relates generally to storage tank liquid level sensor systems and methods, and more specifically to improved accuracy radar sensor liquid level detection systems and methods for level sensing in mobile, low-profile liquid storage tanks.

Sensor systems are well known and in widespread use for sensing liquid levels in large capacity industrial storage tanks in industrial settings and industrial processes. More specifically, radar sensor systems exist which beneficially monitor liquid levels in industrial applications, particularly with respect to preventing an undesirable overfilling of liquid storage tanks. While such radar sensor systems may work rather well in such industrial liquid monitoring applications, they are disadvantaged in some aspects for monitoring liquid level in storage tanks that are outside of the industrial realm.

For example, lower capacity storage tanks in non-industrial settings, and particularly mobile storage tanks that are movable to different locations, present additional challenges that can undesirably impact radar sensor measurements of liquid level, rendering existing radar sensor systems unreliable and therefore impractical for meaningful use in certain applications. Particularly for mobile, low-profile liquid storage tanks which are widely utilized in certain types of vehicles, conventional radar sensor systems are prone to unacceptable inaccuracies in sensing liquid levels. Improved liquid level detection systems and methods are therefore desired.

### BRIEF DESCRIPTION OF THE DRAWINGS

Non-limiting and non-exhaustive embodiments are described with reference to the following Figures, wherein like reference numerals refer to like parts throughout the various drawings unless otherwise specified.

FIG. 1 is a perspective view of an exemplary mobile, liquid storage tank.

FIG. 2 is a cross-sectional view of the mobile, liquid storage tank shown in FIG. 1 illustrating issues posed in the accurate determination of a sensed liquid level with a radar sensor.

FIG. 3 is a cross-sectional view similar to that of FIG. 2 including an exemplary radar sensor system in accordance with an embodiment of the present invention.

FIG. 4 illustrates a monostatic radar sensor implementation of the radar sensor system shown in FIG. 3 in accordance with an exemplary embodiment of the present invention.

FIG. 5 illustrates a bistatic radar sensor implementation of the radar sensor system shown in FIG. 3 in accordance with an exemplary embodiment of the present invention.

FIG. 6 illustrates a first multiple-input multiple-output (MIMO) radar sensor implementation of the radar sensor system shown in FIG. 3 in accordance with an exemplary embodiment of the present invention.

FIG. 7 illustrates a second multiple-input multiple-output (MIMO) radar sensor implementation of the radar sensor system shown in FIG. 3 in accordance with an exemplary embodiment of the present invention.

FIG. 8 illustrates an exemplary operation of a first portion of the MIMO radar sensor implementation shown in FIG. 7.

FIG. 9 illustrates an exemplary operation of a second portion of the MIMO radar sensor implementation shown in FIG. 7.

FIG. 10 illustrates an exemplary radar power plot for a first transmitter/receiver pair shown in FIG. 8.

FIG. 11 illustrates an exemplary radar power plot for a second transmitter/receiver pair shown in FIG. 8.

FIG. 12 illustrates an exemplary radar power plot for a third transmitter/receiver pair shown in FIG. 8.

FIG. 13 illustrates an exemplary radar power plot for a first transmitter/receiver pair shown in FIG. 9.

FIG. 14 illustrates an exemplary radar power plot for a second transmitter/receiver pair shown in FIG. 9.

FIG. 15 illustrates an exemplary radar power plot for a third transmitter/receiver pair shown in FIG. 9.

FIG. 16 illustrates exemplary processes of determining liquid level in a storage tank utilizing the radar sensor systems and implementations of FIGS. 3-9 and operating upon multiple transmitter/receiver pair power plots such as those illustrated in FIGS. 10-15.

FIG. 17 schematically illustrates a liquid level detection radar sensor system in accordance with an exemplary embodiment of the present invention.

### DETAILED DESCRIPTION

In order to understand the inventive concepts described herein to their fullest extent, some discussion of the state of the art and certain problems and disadvantages that exist in the art is set forth below, followed by exemplary embodiments of improved radar sensor systems and methods that advantageously overcome the limitations of existing liquid level detection systems.

Apart from sophisticated industrial monitoring systems for large high-capacity industrial storage tanks, relatively unsophisticated sensor systems exist to measure liquid levels in relatively small, low-capacity liquid storage tanks outside of industrial environments and for non-industrial uses. Unlike high-capacity industrial liquid storage tanks that are stationary by design, such low-capacity tanks are relatively small and lightweight and are therefore mobile in that they are easily transported from location to location for desired use, and in some cases may supply or collect liquid while in transit.

Relatively low cost probe sensors are known that extend inside such mobile storage tanks to provide a rudimentary form of liquid level detection inside the tank. The probe sensors may be plug-type sensors that are attached to the tank from the outside, but extend into the tank for liquid level detection at designated positions on the tank interior. For example, four probe sensors may be utilized in combination at correspondingly different elevations to detect, for example, a full tank, a ⅔ full tank, and a ⅓ full tank via three of the respective probe sensors provided, with the fourth probe sensor at the bottom of the tank providing electrical conductivity for the operation of the other three probe sensors. Such large gradation in liquid level detection presents significant undesirable ambiguity in the amount of liquid actually in the storage tank and therefore frustrates proactive management of the liquid in the tank that may otherwise be desired in certain end use applications.

For example, the actual liquid level in a mobile tank may become a critical concern for an owner of a recreational vehicle (RV) or another similarly situated vehicle because the amount of available water may affect the practical use, enjoyment and operation of the vehicle. For instance, when the vehicle owner or operator may not easily or quickly be able to replenish a water supply tank at the present location of the vehicle or when a grey or black water tank may unexpectedly fill without a corresponding ability to empty the tank at the current location of the vehicle, the vehicle may be rendered partly inoperable in important aspects to the end user. Because of the large gradation in liquid level sensing when probe sensors are utilized, however, the actual water level in the tank may be considerably different than that indicated by the probe sensors. A more accurate and reliable liquid sensor system is therefore desired which affords a more meaningful opportunity for the vehicle owner, vehicle operator or affected occupants of the vehicle to take more proactive steps to manage water use and when needed, to conserve water until the storage tank can be replenished or refilled or until a grey or black water tank can be emptied.

Apart from ambiguity issues regarding specifically how full a tank may be at any time, reliability of known probe sensors can be particularly affected by sediment or solids inside the storage tank being monitored. Specifically for grey water or black water tanks that collect non-potable water, sediment inside the tanks may affect the operation of one or more of the probes to the point where they may fail to detect the corresponding liquid level in the tank at all. Once the grey or black water tanks are full, key functionality of the RV may be compromised, including but not limited to any further use of fresh water in the vehicle that may otherwise be available. Surprises in liquid level for grey or black water tanks are therefore particularly unwelcome and more reliable liquid level sensors are needed.

The issues posed by probe sensors above are partly solved by existing alternative capacitive sensors that may be attached to an exterior side wall of a mobile storage tank. Capacitive sensors of this type may include two vertical strips of metal with small horizontal spacing between them. The capacitance between the strips varies depending on the level of the liquid in the tank. Some capacitive sensors consist of a single large vertical strip with additional smaller strips arranged as an array in a predetermined vertical spacing from one another. The array of smaller strips is positioned to the side (horizontally) of the larger vertical strip. Each smaller strip in the array detects the water level through the tank side wall at the corresponding elevation of each strip on the side wall. Because such capacitive sensors are not inside the tank they are not as prone to reliability issues because of conditions inside the tank, and more capacitive strips can easily be provided to realize a finer gradation in measured liquid levels such as in 3-5% increments instead of 33% increments via sensor probe systems. Less ambiguity in actual water level via finer gradation of water level detection is therefore possible, although the capacitive sensors in the array can sometimes be unreliable and can introduce additional expense and complication due to the greater number of sensors needed to operate this type of system.

For instance, to sense the full range of zero to 100% liquid level in the tank in 5% increments, 20 sensors would be needed on the tank side wall. A relatively complex communication and control setup would also be needed to independently operate the 20 sensors, process the sensor outputs and provide the desired water level output over time for the benefit of the end user or an automated control system. Such expense and complication in the communication and control setup would further be incurred on a per-tank basis, so a monitoring of three liquid storage tanks with sensors arranged to measure liquid level in 5% increments each would require 60 sensors (20 for each of the three tanks) that would individually need to communicate with a centralized processing unit. System installation and setup, as well as diagnosing and troubleshooting a system having such a large number of sensors to achieve and maintain its full operation can be challenging and at least for certain systems and certain end users would preferably be avoided. Simpler sensors systems are therefore desired.

Float sensors are sometimes used in small mobile tanks such as vehicle fuel tanks. However, float sensors are not reliable in black and grey water conditions.

Ultrasonic sensors have also been used for level sensing in mobile, low-profile storage tanks but with limited success. The physics of acoustic wave propagation through the liquid being measured and the bandwidth available for ultrasonic sensors are limiting factors in the performance of these types of sensors. Radar sensors offer promise to provide precise, accurate, real-time and non-gradated liquid level determination for a mobile storage tank. As noted above, radar sensor liquid level detection systems exist that work well to monitor liquid levels in large capacity, stationary storage tanks in industrial settings, but they are disadvantaged for use in smaller capacity, mobile tanks in non-industrial settings. For example, smaller and lighter storage tanks that may be moved from location to location, including but not limited to storage tanks that are components of vehicle systems, require smaller and more economical sensor components and controls relative to industrial counterpart systems.

Radar sensors for mobile, low-profile storage tanks do currently exist in the marketplace but with limited or poor performance because of the challenges described below.

For a storage tank that is relatively small and shallow, sometimes referred as “low-profile” storage tank which is specifically contrasted with relatively large and tall/deep tanks used in industrial applications, additional challenges exist to realizing accurate and useful liquid level sensing via radar sensors that are located outside of the storage tank and therefore measure the liquid level through a top wall of the tank. Unlike their larger industrial counterparts, smaller, low-profile storage tanks may have, and often do have, a non-uniform wall thickness, resulting in radar sensor readings of liquid level that are less accurate than desired. In a shallower storage tank, inaccurate radar readings of liquid levels attributable to variations in the top wall of the tank can be considerably more consequential from a controller and oversight perspective than in deeper tanks.

As a simple example, consider a generally rectangular storage tank having a shallower depth (measured in a vertical direction or the height direction) of 12 inches as opposed to a much taller storage tank having a depth of 120 inches. If a variation in the top wall surface of each of these tanks causes errors in measurements that are within 2 inches of the top of the tank, then the larger tank will exhibit errors when it is more than 98% full but the smaller tank will exhibit errors when it is more than 83.3% full. This is not acceptable for storage tanks in a RV, food truck or recreational boat.

The unwelcome result from the examples above is that the actual water level in the tank in an RV, food truck or recreational boat using existing sensor technology may not be reliably determined. Detected levels by existing sensor technologies may be more or less, and sometimes may be considerably more or less, than the actual liquid level at any given point in time. Particular problems may be presented for grey and black water tanks when the actual liquid level is greater than what existing sensors indicate. In addition to water tanks, parallels exist for monitoring of other types of liquids such as fuel (e.g., gasoline, diesel fuel, propane) that may likewise be utilized in vehicles such as RV's, food trucks and recreational boats.

Still another problem is presented by shallower, low-profile storage tanks as opposed to larger ones, namely that the liquid in the storage tank may condense and collect or build up on the inner surface of the top wall in the form of droplets. When a tank is moved or jostled, splashing may also cause droplets to form on the inner surface of the top wall. If a droplet happens to coincide with the location of a radar sensor transmitter or receiver, the presence of the droplet can affect the radar return and contribute to an erroneous discrepancy in the sensed liquid level versus the actual liquid level in the storage tanks. Similar to the example above relating to wall thickness of the storage tank, such error would be more pronounced in the shallower, low-profile tank than in the deeper tank. Considering that a droplet and a wall imperfection may occur at the same location to affect a radar transmitter or receiver, the variation becomes unpredictable. For example, if variation was caused by the wall thickness alone, the effect could potentially be removed by calibration, but with the addition of variation caused by water droplets that are transitory in nature, calibration is ineffective.

Still further, and depending on the liquid being monitored, a buildup of solids may occur inside the tank that can affect a reading at the location of a radar transmitter or receiver and contribute to an inaccurate liquid level measurement by the transmitter/receiver pair. As used herein, a transmitter/receiver pair is a combination of a transmitter and a receiver. In reference to transmitters and receivers the word “pair” and the word “combination” are both used, with “combination” denoting the possibility of more than one transmitter or more than one receiver as set forth exemplary embodiments described further below Solid buildup may occur separately or may occur in combination with tank wall variations and liquid buildup to produce transitory errors that cannot be removed through calibration. For example, non-potable water storage tanks may include solid contaminants which may produce a degree of solid/liquid buildup in at least some conditions.

Given the issues above, liquid level readings may be highly sensitive to the particular location where a radar transmitter and receiver is installed relative to the mobile storage tank being monitored, meaning that the liquid level readings with the transmitter and receiver may be more accurate or less accurate depending on their particular location relative to the tank. Since the locations of solid/liquid buildup will also change over time, the liquid level readings may be more or less accurate depending on when the readings are made. The accuracy of any given liquid level reading will depend on any variance (or not) in the top wall thickness and on the degree of liquid or solid buildup inside the tank at the specific location where the respective transmitter and receiver are installed at the time that the liquid level reading is made. Of course, the installer cannot predict or determine at the point of installation exterior to the storage tank where such wall thickness variation may exist, nor can he determine when or where inside the tank solid/liquid buildup may materialize, so the inevitable result is that any single sensor mounting location will fall short of meeting the needs of the marketplace for accurate liquid level sensing in low-profile mobile storage tanks for vehicle use.

The accuracy of a liquid level measurement is affected by the thickness of the upper wall and the build-up of solids and liquids on the inner surface of the upper wall for two reasons. Firstly, the radar returns through and/or from the upper wall or the build-up can interfere with measurements of the liquid level, with the effect more pronounced when the liquid surface is close to the upper wall or the build-up as described in more detail below. Secondly, the power level of the returns from the surface of the liquid will be reduced if reflections from and absorption by the upper wall or the buildup reduce the received radar signal level.

Turning now to the Figures, exemplary embodiments of mobile storage tanks and liquid level detection radar sensor systems and methods of the present invention therefore will now be described that beneficially overcome the limitations described above with respect to the state of the art. Method aspects will be in part apparent and in part explicitly discussed in the following description.

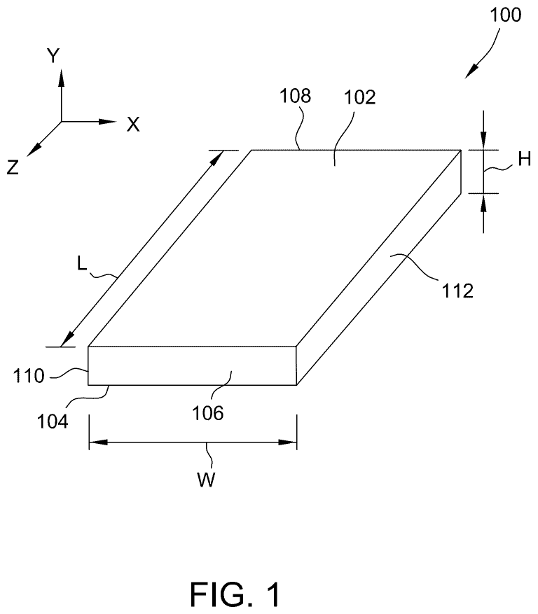

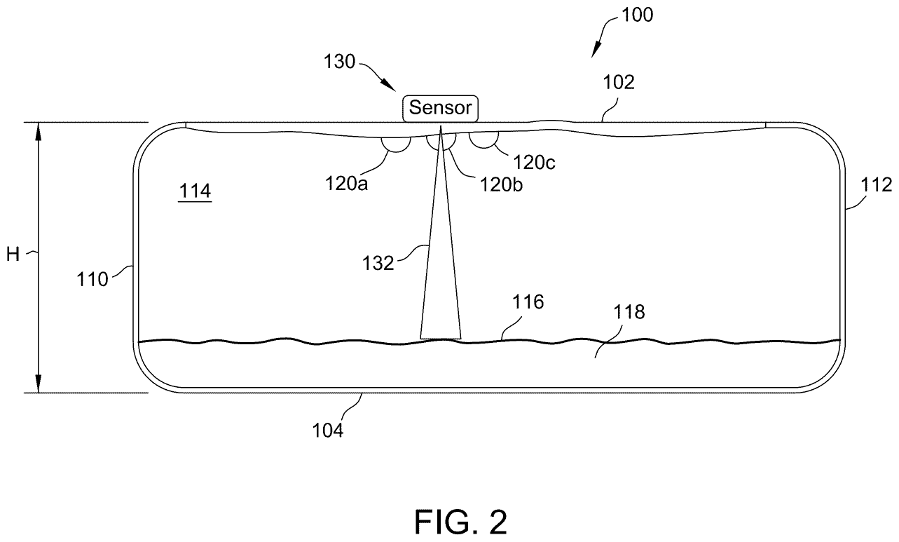

FIGS. 1 and 2 are a perspective view and cross-sectional view, respectively, of an exemplary mobile storage tank 100 upon which the radar sensor system and methods of the present invention described further below are beneficially operable with vastly improved accuracy than existing systems. The storage tank 100 is formed in an elongated rectangular shape in the embodiment shown including a top wall 102, a bottom wall 104 opposing the top wall, lateral end walls 106 and 108 interconnecting opposing edges of the respective top and bottom walls 102 and 104, and longitudinal side walls 110 and 112 interconnecting the respective edges of the walls 102 through 108. The walls 102 through 112 enclose an interior cavity 114 (FIG. 2) having a capacity to store a predetermined amount of liquid therein.

In contemplated embodiments, the liquid capacity of the tank 100 is about 150 gallons or less. In further contemplated embodiments, the capacity of the tank is about 15 gallons to about 150 gallons. In this aspect the capacity of the tank 100 is considerably less than the capacity of a typical industrial liquid storage tank. The reduced capacity of the tank 100 reduces the weight of the storage tank 100 when filled with liquid and reduces the size of the tank, advantageously contributing to the mobility of the tank to be easily transported between different locations for use at different sites.

To further contribute to the mobility of the tank 100, in contemplated embodiments the tank 100 is fabricated from a relatively lightweight non-metal material such as plastic, fiberglass or another suitable material as opposed to heavier metallic materials commonly used to fabricate industrial storage tanks. Non-metallic material construction for the tank 100 is also compatible for use with radar sensors which may easily transmit and receive through the walls of the tank 100 without having to create openings in the tank side walls. It is understood, however, that in some embodiments the tank 100 could be metallic if such openings were included to facilitate an operation of radar sensors located exterior to the tank 100.

The storage tank 100 includes an inlet (not shown) for filling of the interior of the tank 100 with a liquid and an outlet (also not shown) for discharging liquid from the storage tank 100. In some contemplated embodiments, the liquid in the tank 100 is water. Depending on the type of water being stored, the storage tank 100 may sometimes be referred to as a fresh water tank, a grey water tank, or a black water tank in the context of an RV, food truck, living quarters of semi-trucks, or recreational marine vehicles as opposed to large commercial marine vehicles including shipping vessels and industrial vessels that have much higher capacity storage tanks that do not present the same concerns. In other contemplated embodiments, the liquid may be fuel such as gasoline, diesel fuel, or propane in non-limiting examples. It is understood that the sensor systems and methods of the invention are not necessarily limited to any particular type of liquid stored in the tank 100. It is also understood that the sensor systems and methods of the invention are not necessarily limited to vehicle storage tanks.

The storage tank 100 in the example shown has a width dimension W measured along an x axis of a Cartesian Coordinate system, a height dimension H measured along a y axis that is perpendicular to the x axis in the Cartesian Coordinate system, and a length dimension L measured along a z axis that is perpendicular to the x axis and the y axis in the Cartesian Coordinate system. In the example shown, the height dimension H is much smaller than the width dimension W which is in turn smaller than the length dimension L. The disproportionately small height dimension H relative to the width and length dimensions L and W is sometimes referred to as a shallow or low-profile tank configuration. As a result, liquid inside the shallow tank 100 has a reduced depth in the vertical dimension H relative to other tank configurations that do not have a low-profile configuration. While a rectangular-shaped low-profile tank is shown, the tank 100 need not necessarily be rectangular and other low-profile tank shapes such as round, disc-shaped tanks may be likewise adopted as a non-limiting example.

In contemplated examples, the storage tank 100 has a low-profile configuration for use in an RV, a food truck, a recreational boat or a semi-truck with living quarters as non-limiting examples. As such, in contemplated embodiments, the low-profile height dimension of the tank 100 may be between about 2 inches (5.08 cm) and about 30 inches (76.2 cm). In more specific embodiments, the low-profile height dimension of the tank 100 may be between about 4 inches (10.16 cm) and 9 inches (22.86 cm). It should be recognized, however, that such low-profile height dimensions are non-limiting examples. The operation of the inventive sensor systems and methods described below does not necessarily depend on a specific low-profile height dimension of the tank 100, and in some cases the inventive sensor systems and methods could be used satisfactorily on storage tanks that are not low-profile tanks at all.

Often when liquid storage tanks are installed for mobile applications such as RVs, very little space remains between the top of the tank and the structure above it. Thus, a low-profile sensor is also needed for the low-profile storage tank 100. Sensor size is typically not a consideration for tanks that do not have similar space constraints or for large-capacity industrial storage tanks. The sensor systems and methods described below are particularly well suited for use as low-profile sensors in applications where other types of larger sensors cannot be used.

Whether or not having a low-profile configuration, the tank 100 in contemplated examples could be used in a non-vehicle application such as a porta-potty as another non-limiting example. The benefits of the invention are not necessarily limited to portable tanks either. For example, the tank 100 could be a septic tank which would benefit from the inventive sensor system apart from any mobility or portability thereof. The exemplary liquid storage tanks described herein are therefore described for the sake of illustration rather than limitation. The benefits of the sensors, systems and method processes described below may generally accrue to various different types of tanks and various different types of liquids wherein liquid level monitoring is desirable.

As shown in cross-sectional view in FIG. 2, the low-profile storage tank 100 is furnished with a low-profile sensor 130 fixedly mounted on the exterior of the top wall 102. The sensor 130 may be a radar sensor which transmits a radar signal 132 from above the tank 100 to and through the top wall 102. The transmitted radar signal is reflected off the surface 116 of the liquid 118 inside the tank 100 and back through the top wall 102 without requiring an opening in the top wall to transmit or receive radar signals. The returned radar signal data may be analyzed by a processor internal to or separately provided from the sensor 130 to determine the vertical distance between the liquid surface 116 and the sensor 130. Once determined, this distance can easily be converted to indicate the amount of liquid (i.e., the liquid level) in the tank on a percentage basis of a full or empty tank as desired. A corresponding output to a human user or to another control device in an automated system can therefore be provided.

Ideally, and in theory, the radar sensor 130 may precisely determine the exact liquid level in the tank 100 without relying upon any other sensing element. As FIG. 2 shows, however, there are at least two non-ideal complicating factors presented by the storage tank 100 that affect the accuracy of the liquid level reading obtained by the radar sensor 130.

First, as shown in FIG. 2 the tank 100 has a non-uniform wall thickness in the top wall 102 that affects the radar signal transmission in a manner that tends to reduce the accuracy of the measured liquid level. In the example shown, the thickness of the top wall through which the radar signal 132 from the sensor 130 travels is greater (or smaller) than the top wall thickness at other locations along the top wall 102. Radar signal transmission through different wall thicknesses will produce varying radar signal returns which can distort the measurements. For example, the speed at which the radar signal 132 propagates in the material of the top wall 102 differs from the speed at which the radar signal 132 propagates in the air below the top wall. This difference in propagation speed will impact the detected vertical distance between the surface 116 of liquid 118 and sensor 130. Also, reflection of radar signal 132 from the interface between the top wall 102 and the air below may interfere with the reflection from the surface 116 of liquid 118. The ability to separate the reflection from the top wall 102 and the surface 116 becomes more difficult when the location of the surface 116 is close to the top wall, which occurs when the liquid level is near the top of the tank. These and possibly other phenomena introduce error in the measured result, or a discrepancy between the detected liquid level and the actual liquid level, which may be more pronounced when the water level is near the top of the tank.

As a practical matter, a deviation in thickness of the top wall 102 would not be evident in the installation of the sensor 130, and depending on whether the wall thickness is thinner or thicker, the inaccuracy or error in the sensed result could skew positively or negatively from the actual liquid level in the storage tank 100, especially when the liquid level is near the top of the tank. That is, the sensed liquid level could be under or over the actual liquid level in an unexpected and non-intuitive manner to the interested end user of the liquid in the storage tank 100. Given that some variance may exist between different tanks 100 in this aspect, considerably different performance variations of the sensor 130 may be observed in use on otherwise similar storage tanks 100 with the sensor 130 installed in the same relative position on the storage tanks 100. Such performance variation of the sensor may perhaps invoke understandable but false impressions by end users that the sensor 130 is not working properly. Methods to calibrate the sensor 130 or to process the sensor output in a manner which would compensate for variance in tank construction are not currently known in the art particularly with the compounding effects of liquid and solid buildup.

Second, and as also illustrated in FIG. 2, liquid buildup in the form of droplets 120a, 120b, and 120c are seen clinging to the inner surface of the top wall 102 of the tank 100. Such droplets may form in a generally unpredictable manner in use of the storage tank 100. One of them, namely the droplet 120b, is located in a position where the transmitted and reflected radar signal will have to pass through the droplet 120b. Again, the passage of transmitted or reflected radar signals through the droplet will produce some variation in the returned signal relative to transmitted or reflected radar signals that do not pass through a droplet. Additionally, radar reflections can be present from the top and bottom surfaces of the droplet 120b, further deteriorating the accuracy of the radar measurement of the water level. Since the presence of droplets may be transient, it is unclear how to calibrate the sensor 130 or to process the sensor output in a manner which would compensate for their presence, since they may be present at times and not present at other times. Further, in some situations droplets may be present but are nonetheless unproblematic as they are located in areas that simply do not affect the radar signal transmission.

Solids may also accumulate and build up on the inner surface of the top wall of the tank depending on the type of liquid being monitored inside the tank 100. As such, instead of liquid droplets, the elements 120a, 120b, and 120c could represent solids which could produce further variance in the sensor reflected radar signal output via transmitted and received radar signals passing through or reflections from the solid material clinging to the top wall 102 inside the tank 100. Such solid buildup would likewise occur in a manner that could not practically be predicted and may be transient in nature such that it may intermittently affect the measured liquid level by the sensor 130. On occasion, both solid and liquid buildup may combine such that transmitted and received radar signals must pass through and may be reflected from each of solid and liquid buildup producing variance in the measured sensor readings of the liquid level. Once again, practical methods to calibrate the sensor 130 or to process the sensor output in a manner which would compensate for the obstruction of radar signal transmissions through solid buildup inside the storage tank 100 are unknown particularly because of the transitory nature of solid buildup and the potential for water buildup that is also very transitory.

In the example of FIG. 2, the sensor signal transmission 132 at the location shown is affected by wall thickness deviation and the presence of solid or liquid buildup represented by 120b. As such, an accumulation of variance in the returned radar signal and the resultant measured liquid level output would occur, and an associated accumulation of error or discrepancy between the actual liquid level and the detected liquid level would be present. Importantly, and as discussed above, the shallower the tank 100 is (i.e., as the low-profile height dimension H becomes smaller) the more pronounced the errors become because the error prone region near the upper wall of the tank would occupy a larger percentage of the total height. The magnitude of the errors may generally be unpredictable from tank to tank and may vary in different operating conditions, generally to the detriment of other systems and persons who depend on the sensed result.

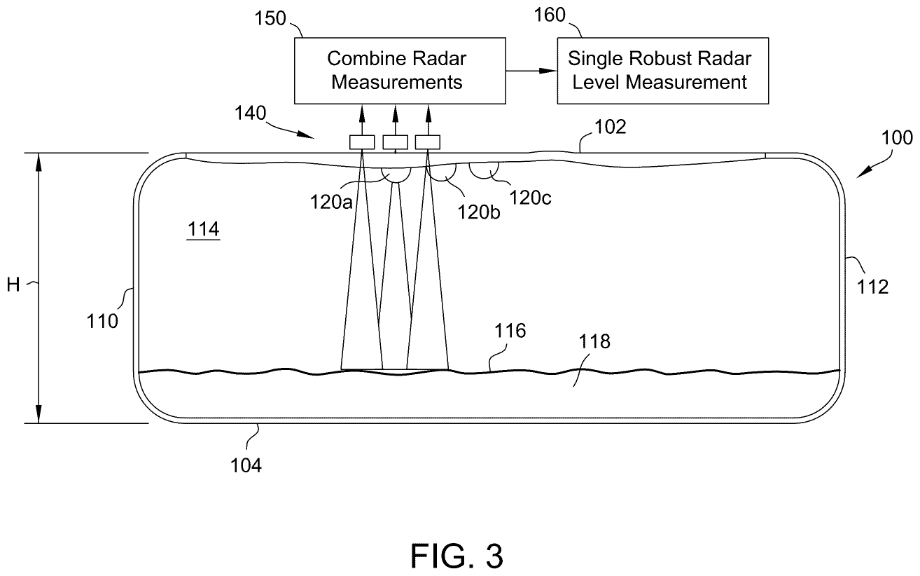

FIG. 3 is an exemplary cross-sectional view similar to that of FIG. 2 but showing an exemplary radar sensor arrangement 140 in accordance with an embodiment of the present invention. Unlike FIG. 2, the tank 100 is now furnished with three discrete radar sensors each independently transmitting radar signals from a transmitter through the top wall 102 of the tank 100 and collecting return signals with a receiver back through the top wall 102. The return signals from each of the three sensors are processed to determine respective liquid levels based on the data from each sensor at each respective location. Output data sets from each of the three transmitter/receiver pairs within the three sensors are, in turn, provided to a processor-based device 150 which combines their outputs to produce a single robust radar level measurement 160 in a manner that reduces errors and magnitude of errors when present due to localized effects in the radar measurements attributable to the construction of the tank 100 and operating conditions inside the tank 100 (e.g., solid and liquid buildup) as discussed above. The processor-based device 150 accordingly provides a single, robust liquid level output measurement 160 that may be more reliably acted upon by control systems and persons to take appropriate actions in view of the liquid level in the tank 100.

In the example of FIG. 3, the three radar sensors from left to right respectively operate with respect to a first signal transmission path that passes cleanly through the top wall 102, a second signal path that passes through the top wall and the thickest portion of the solid/liquid buildup 120a, and a third signal path that passes through the top wall and tangentially through the water droplet 120b. The result will be three different liquid level values detected by each of the three sensors which experience different effects particular to the specific locations from which they operate. Because the three different radar sensors at the three different locations will have different returns from near targets (e.g., the tank wall, clinging water, or clinging solids) the measurements from the three radar sensors can be combined into a single more accurate measurement that is robust to measurement variation caused by the near targets. Mitigation of errors in the individual operation of each sensor is possible with intelligent processing of the sensor outputs as further explained below. While three radar sensors are shown in FIG. 3, similar advantageous effects could be realized with as few as two sensors with two transmitter/receiver pairs or more than three sensors with more than three transmitter/receiver pairs in further and/or alternative embodiments.

Those who are skilled in the art will understand that in standard usage, a transmitter may refer to the radar circuitry that drives an antenna, the antenna itself, or the combination of the circuitry and the antenna. For the purposes of this specification and claims, language that refers to the location or position of the transmitter is intended to describe the location of the transmit antenna that is connected to the radar transmit circuitry. Besides the well understood considerations of transmit loss that may occur between the antenna and the circuitry, the location of the circuitry itself is not important to the functionality of the sensors, systems or methods described herein.

Similarly, those who are skilled in the art will understand that in standard usage, a receiver may refer to the radar circuitry that receives the signal from an antenna, the antenna itself, or the combination of the circuitry and the antenna. For the purposes of this specification and claims, language that refers to the location or position of the receiver is intended to describe the location of the receive antenna that is connected to the radar receive circuitry. Besides the well understood considerations of transmit loss that may occur between the antenna and the circuitry, the location of the circuitry itself is not important to the functionality of the sensors, systems or methods described herein.

Additionally, language herein that refers to the location or position of a transmitter/receiver pair is meant to describe the location or position of the antennas corresponding to the associated transmit circuitry and receive circuitry.

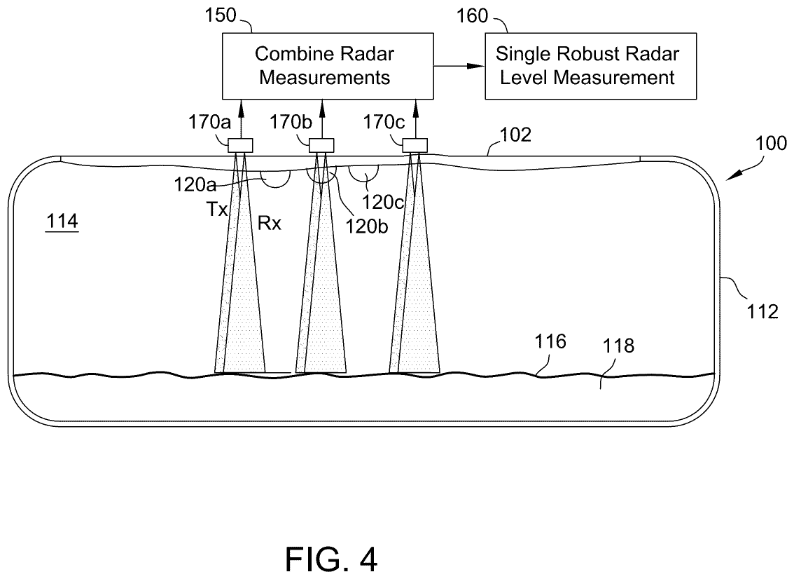

FIG. 4 illustrates a first exemplary radar sensor implementation of the radar sensor system shown in FIG. 3. As shown in FIG. 4, the tank 100 is furnished with three independently operable monostatic radar transmitter/receiver pairs 170a, 170b, and 170c fixedly mounted in spaced-apart relation to one another on the exterior of the top wall 102 of the tank. Monostatic radar circuitry can be designed such that the transmit and receive antennas are in fact the same antenna. In these designs the location of the antenna constitutes the location of the transmitter/receiver pair. In other designs, the transmit and receive antennas are separate antennas, but they are located sufficiently near each other that the design is considered a monostatic radar design. Each radar transmitter/receiver pair 170a, 170b, 170c respectively includes a transmitter Tx and a receiver Rx that are collocated to transmit and receive radar signals toward the surface 116 of the liquid 118 and back. Because of the different locations of the transmitter/receiver pairs 170a, 170b, and 170c different returns from near targets (e.g., the tank wall, clinging water, or clinging solids) are presented. Adoption of three transmitter/receiver pairs within radar transmitter/receiver pairs 170a, 170b, and 170c at three different locations reduces localized effects by each transmitter/receiver pair that are not likely to be duplicated at each location, such that localized radar signal variance at any one of the locations sensed will not influence the result in the same way relative to a single transmitter/receiver pair operation (FIG. 2).

Adoption of three spaced-apart transmitter/receiver pairs to take three independent liquid level readings at three different locations provides a set of radar readings with an increased possibility of determining an accurate measurement of liquid level. In the example shown in FIG. 4, each of the three transmitter/receiver pairs 170a, 170b, and 170c transmits and receives through respectively different wall thickness at each location, and only one of the three transmitter/receiver pairs, namely the transmitter/receiver pair 170b, transmits and receives through solid/liquid buildup 120b. The solid/liquid buildup 120a, 120b, and 120c does not impact the operation of the radar transmitter/receiver pairs 170a or 170c, such that the operation of the radar transmitter/receiver pairs 170a and 170c is likely to be more accurate and reliable than the operation of the radar transmitter/receiver pair 170b.

In order to mitigate errors represented in the output from each individual transmitter/receiver pair, the processor-based device 150 may combine the outputs of the transmitter/receiver pairs into a single output 160 using algorithms that apply one or more of the following non-limiting operations in contemplated examples: (1) Averaging measurements from all transmitter/receiver pairs; (2) Averaging measurements from all transmitter/receiver pairs that have near-range returns (meaning returns from surfaces very near the sensor) below a specified power threshold; (3) Averaging measurements from all transmitter/receiver pairs that produce liquid level measurements in an expected range; (4) Selecting only the measurement from the transmitter/receiver pair with the lowest near-range return; or (5) Selecting only the liquid level measurement that is closest to an expected measurement.

The operation that averages measurements from all three transmitter/receiver pairs operates in the example of FIG. 4 to mitigate individual error, if present, from one or more of the transmitter/receiver pairs. In the example of FIG. 4, the measurements from transmitter/receiver pairs 170a and 170c are presumably more accurate than the measurement from transmitter/receiver pair 170b because of the buildup 120b that impacts the transmitter/receiver pair 170b but not the transmitter/receiver pairs 170a and 170c. Averaging detected liquid levels of the three transmitter/receiver pairs will reduce the impact of the buildup 120b in the end output 160. For example, if the transmitter/receiver pairs 170a and 170c each return the same result (e.g., liquid level of 0.10 m or 3.94 inches) and the transmitter/receiver pair 170b returns a liquid level of 0.11 m or 4.33 inches, the average of the three liquid level values is 0.103 m or 4.07 inches. The combined output in this example is a bit above the most accurate transmitter/receiver pair readings but considerably less than the most inaccurate transmitter/receiver pair reading.

Likewise, in the example of FIG. 4 and in the aspect of tank wall thickness, the operation of radar transmitter/receiver pair 170c will vary from the operation of the radar transmitter/receiver pair 170b because of the variability of thickness of the top wall. Specifically, the top wall thickness at the location of transmitter/receiver pair 170c is smaller than the top wall thickness at the location of transmitter/receiver pair 170b. The radar return through the increased top wall thickness may be smaller or larger than the radar return through the decreased wall thickness because the transmission through a dielectric slab, like the plastic wall of the tank, depends cyclically on the slab thickness. Averaging detected values from the three transmitter/receiver pairs will reduce the impact of the variable wall thickness and any related distortion in the combined output 160.

Averaging measurements from all three radar transmitter/receiver pairs that have returns at a specified near range below a specified threshold in the example of FIG. 4 will eliminate any transmitter/receiver pair reading that is outside the threshold from the combined output 160. For example, the threshold may operate to eliminate the reading from the transmitter/receiver pair 170b in the example of FIG. 4 from the end output 160. This improves the accuracy relative to averaging all three transmitter/receiver pair values because the liquid level from transmitter/receiver pair 170b would be less accurate than the liquid level from transmitter/receiver pairs 170a and 170c due to the signal variance caused by buildup 120b. Because the radar return at the specified near range from the transmitter/receiver pair 170b would fall outside the threshold due to the stronger radar return from the solid/liquid buildup 120b, the end output 160 would be the average of the two transmitter/receiver pairs 170a and 170c that are not impacted by solid/liquid buildup. The specified near range at which the returns are evaluated for comparison to the specified threshold could be chosen to correspond to the typical range for returns from top wall of the tank or from the water/solids that build up on the top wall of the tank. The specified threshold for returns at the specified range could be theoretically calculated based on typical near range returns, expected operating conditions of the tank, and other pertinent factors. Likewise, the thresholds could be empirically determined to optimize accuracy of the sensor output 160 based on actual operating conditions. Aspects of machine learning can be incorporated to adjust the threshold over time and provide increasingly accurate results in the output 160.

Averaging measurements from all radar transmitter/receiver pairs that have liquid level measurements in an expected range is another way to avoid inclusion of a transmitter/receiver pair reading in the combined output 160 that would otherwise skew the result to become less accurate, without requiring a more complicated assessment of determining which of the sensed measurements are correct, or close to being correct, as opposed to sensed measurements that are not. For example, the expected range could be set to plus or minus 10% from the average detected liquid level by all transmitter/receiver pairs. As such, if one of the transmitter/receiver pair detected levels is 10% higher or lower than the average of the liquid levels from all transmitter/receiver pairs, it may be excluded from the combined output 160. For example, considering three transmitter/receiver pair liquid level readings of 0.100 m (3.94 inches), 0.106 m (4.17 inches) and 0.085 m (3.35 inches), with an average of 0.097 m (3.82 inches) the third transmitter/receiver pair could be excluded since it is 12% below the average. The combined output is therefore the average of only the first two transmitter/receiver pair readings or 0.103 m (4.06 inches). The combined output in this example is between the most accurate transmitter/receiver pair readings and is considerably more accurate than the most inaccurate transmitter/receiver pair reading.

As another example, an expected range for purposes of improving accuracy in the combined output 160 could be based on a previous combined output 160 at an earlier point in time. Intelligence could be built-in to the system to track liquid usage (i.e., rate of tank emptying or tank filling) over time and based on associated stored data, the processor 150 could determine an expected value for each iterative sensed value at a subsequent point in time.

For instance, if the combined output 160 from the last sensed iteration of a freshwater tank indicated a detected liquid level of 6 inches in the tank 100 and that an expected liquid usage rate would be 0.2 inches for the next hour, the liquid level in the tank would be expected to fall during that hour. If a liquid level reading from one of the transmitter/receiver pairs showed the same as the combined output liquid level from an hour previous (i.e., 6 inches), it would be excluded from the combined output when the other two transmitter/receiver pair readings both show lower liquid levels as expected. Likewise, if any of the transmitter/receiver pair readings show a higher liquid level than the previous reading that would likewise be an unexpected result, that liquid level would be excluded in the combined output 160. In a tank where the liquid level was expected to rise over time, similar expectations could be applied but in reverse (i.e., transmitter/receiver pair readings showing lower levels than previous detections or unexpectedly low liquid levels relative to prior detected levels could be excluded in the combined output 160.) Such considerations apply a logical rule of reason to transmitter/receiver pair readings as compared to one another and to previously determined combined outputs 160 over time.

Selecting only the liquid level measurement from the radar transmitter/receiver pair with the lowest near-range return effectively imposes a selection of the least corrupted reading from the three transmitter/receiver pairs. The lowest near-range return would correspond to the sensor that was least affected by localized conditions and associated variance in returned radar signals that tend to produce errors in the sensed result.

Selecting only the measurement that is closest to an expected measurement is another way to impose a selection of the most accurate reading from the three transmitter/receiver pairs, and to reject inaccurate transmitter/receiver pair readings. Expected measurements may be determined in the manner described above for purposes of selecting the closest measurement to an expected value. That is, an expected result could be based on historical data collected by the sensor system over time.

While the embodiment of FIG. 4 uses three radar sensors, it will be appreciated that the three spaced apart measurements could be obtained with a single radar sensor that switches between three different antennas or three different transmit/receive antenna pairs that are spaced apart from one another, for example in the positions of radar sensors 170a, 170b, and 170c in FIG. 4.

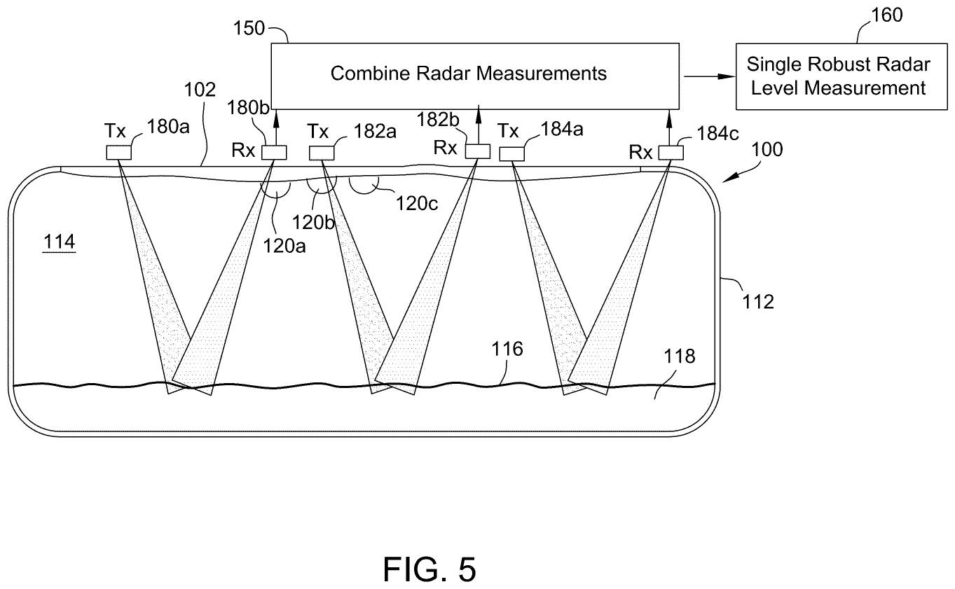

FIG. 5 illustrates a bistatic radar sensor implementation of the radar sensor system shown in FIG. 3 in accordance with an exemplary embodiment of the present invention. Three bistatic radar sensors are shown each including a transmitter/receiver pair in spaced relation from one another on the top wall 102 of the storage tank 100. Specifically, a first bistatic radar sensor includes a first radar transmitter 180a and a first radar receiver 180b, a second bistatic radar sensor includes a second radar transmitter 182a and a second radar receiver 182b, and a third bistatic radar sensor includes a third radar transmitter 184a and a third radar receiver 184b. Each transmitter/receiver pair is operable in the respective locations shown, with each transmitter/receiver pair producing different return effects due to variances in the top wall thickness of the storage tank and due to the presence or absence of liquid/solid buildup 120a, 120b, and 120c. Algorithmic signal processing techniques such as those described above may be applied on the respective radar measurements of each radar transmitter/receiver pair with similar effect by the processor-based device 150 to produce a combined output 160 with improved accuracy that can be reliably applied to take desired actions in response for the end output 160 of the detected liquid level in the storage tank 100.

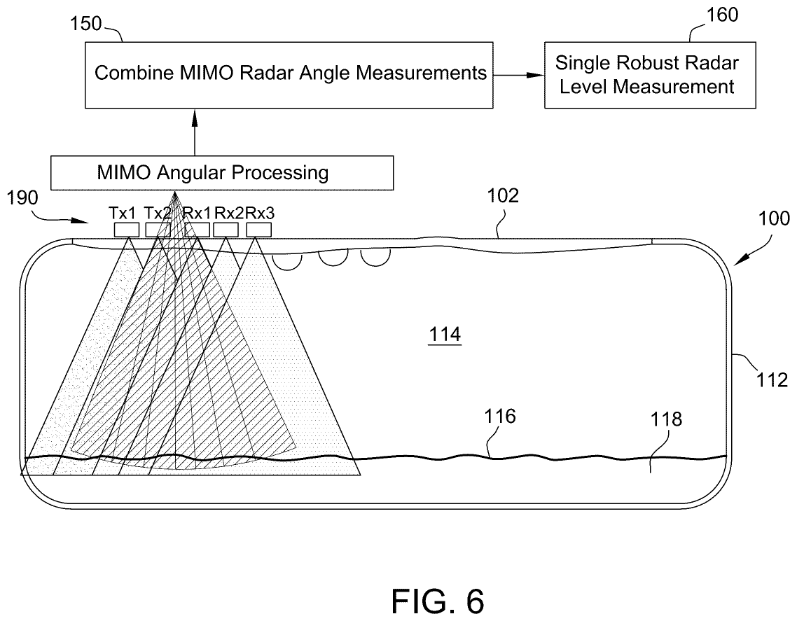

FIG. 6 illustrates a first multiple-input multiple-output (MIMO) radar sensor implementation of the radar sensor system shown in FIG. 3 in accordance with an exemplary embodiment of the present invention. A MIMO radar sensor 190 is shown having two radar transmitters Tx1 and Tx2 and three radar receivers Rx1, Rx2, and Rx3 at respectively different locations on the top wall 102 of the storage tank 100. The radar transmitters Tx1 and Tx2 transmit orthogonal signals that can be separated when received. This can be done by using respectively different (e.g., orthogonal) radar signals or by transmitting similar radar signals but at different times. The transmitters Tx1 and Tx2 transmit through the top wall 102, reflected signals of which may each be received by each respective radar receiver Rx1, Rx2, and Rx3. Known MIMO Angular Processing may be performed on the set of signals from each combination of a transmitter and a receiver and input into the processor-based device 150 for determination of a corresponding detected liquid level in the storage tank 100.

Algorithmic signal processing techniques such as those described above may be applied on the respective angle measurements with similar effect by the processor-based device 150 to produce a combined output 160 with improved accuracy that can be reliably applied to take desired actions in response for the end output 160 of detected liquid level in the storage tank 100. Specifically, the processor-based device 150 may combine the radar receiver outputs into a single output 160 using algorithms that apply one or more of the following operations in non-limiting examples of contemplated embodiments: (1) averaging measurements from all angles calculated from the combination of transmitters and receivers; (2) averaging measurements from all angles calculated from the combination of transmitters and receivers that have near-range return power below a specified threshold; (3) averaging measurements from all angles calculated from the combination of transmitters and receivers that are in an expected range; (4) selecting only the measurement from the angle calculated from the combination of transmitters and receivers with the lowest near-range return power; and (5) selecting only the measurement from the angle calculated from the combination of transmitters and receivers that is closest to an expected measurement.

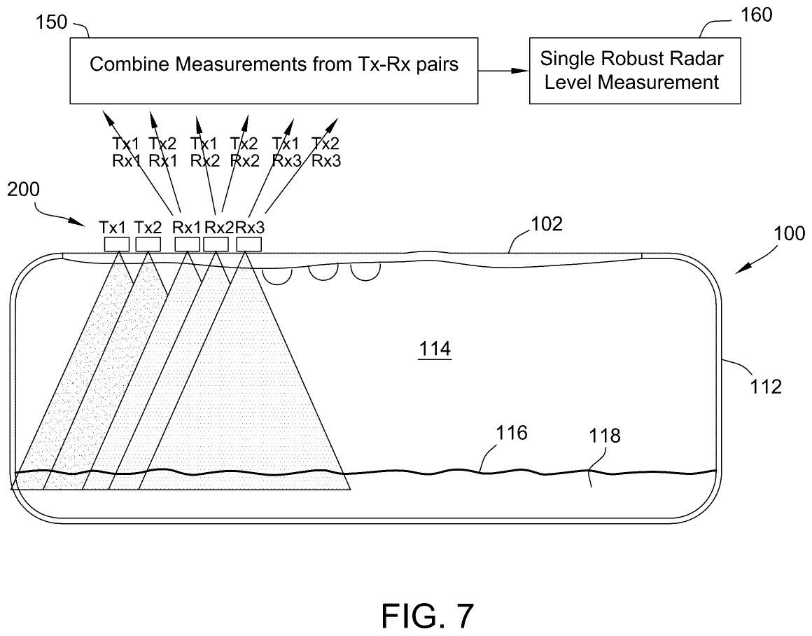

FIG. 7 illustrates a second multiple-input multiple-output (MIMO) radar sensor implementation of the radar sensor system shown in FIG. 3 in accordance with an exemplary embodiment of the present invention. A MIMO radar sensor 200 is shown having two radar transmitters Tx1 and Tx2 and three radar receivers Rx1, Rx2, and Rx3 at respectively different locations on the top wall 102 of the storage tank 100. The radar transmitters Tx1 and Tx2 generate respectively different radar signals and transmit them through the top wall 102, reflected signals of which may each be received by each respective radar transmitter Rx1, Rx2, and Rx3. Instead of MIMO Angular Processing, however, liquid level measurements are obtained from each of the received radar signals and input into the processor-based device 150 for determination of a corresponding detected liquid level in the storage tank 100. Since there are two transmitters and three receivers, a total of six liquid level measurements are taken and combined by the processor-based device 150 to produce the combined output 160 with improved accuracy. Of course, greater or fewer numbers of transmitters and receivers could be incorporated in another embodiment to provide varying numbers of liquid level measurements for consideration in determining the combined output 160.

Specifically, and as shown in FIG. 7, the six liquid level measurements include a first liquid level measurement from the transmitter/receiver pair Tx1 and Rx1, a second liquid level measurement from the transmitter/receiver pair Tx1 and Rx2, a third liquid level measurement from the transmitter/receiver pair Tx1 and Rx3, a fourth liquid level measurement from the transmitter/receiver pair Tx2 and Rx1, a fifth liquid level measurement from the transmitter/receiver pair Tx2 and Rx2, and a sixth liquid level measurement from the transmitter/receiver pair Tx2 and Rx3.

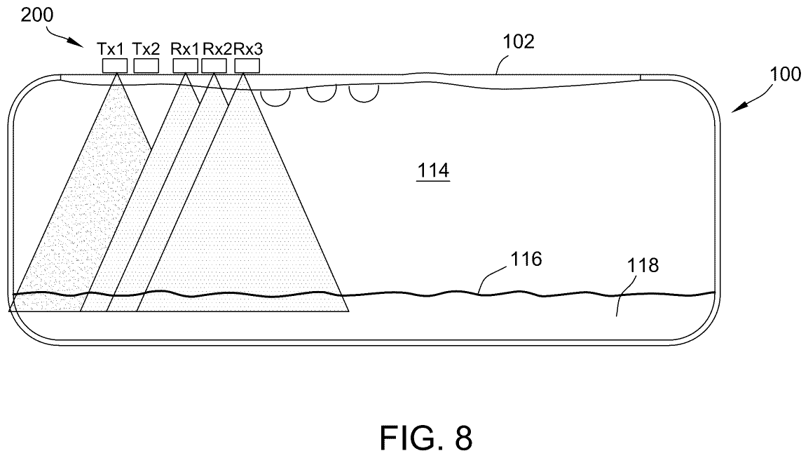

FIG. 8 illustrates an exemplary operation of a first portion of the MIMO radar sensor 200 with the transmitter Tx1 generating a radar signal that is transmitted through the top wall 102 and reflected back to the receivers Rx1, Rx2, and Rx3 through the top wall 102 to generate three liquid level measurements based upon the transmission from Tx1. With Tx1 transmitting, signals are received at Rx1, Rx2, and Rx3, and then the mathematical Fast Fourier Transform (FFT) is applied to convert the radar time domain signal into frequency domain signal. In Frequency Modulated Continuous Wave (FMCW) radar systems, conversion from the time domain to the frequency domain provides range discrimination. As such FFT conversion in FMCW radar systems for range discrimination is well known in the radar industry, it is not described further herein.

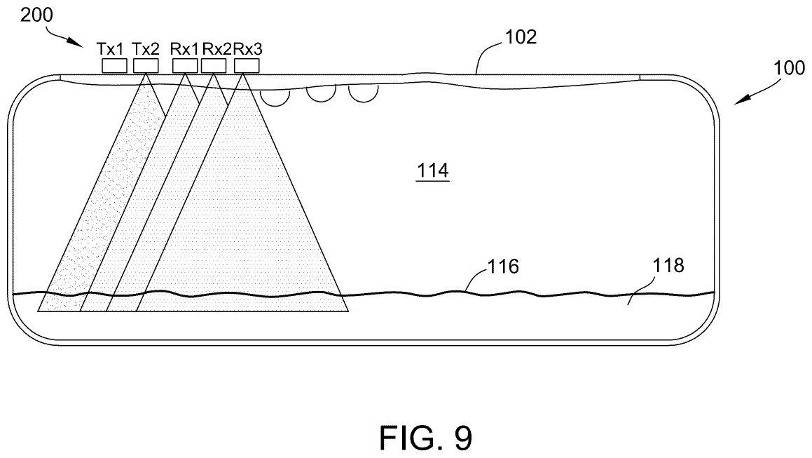

FIG. 9 illustrates an exemplary operation of a second portion the MIMO radar sensor 200 with the transmitter Tx2 generating a radar signal that is transmitted through the top wall 102 and reflected back to the receivers Rx1, Rx2, and Rx3 through the top wall 102 to generate three liquid level measurements based upon transmissions from Tx2. With Tx2 transmitting, signals are again received at Rx1, Rx2, and Rx3, and the range FFT is again computed.

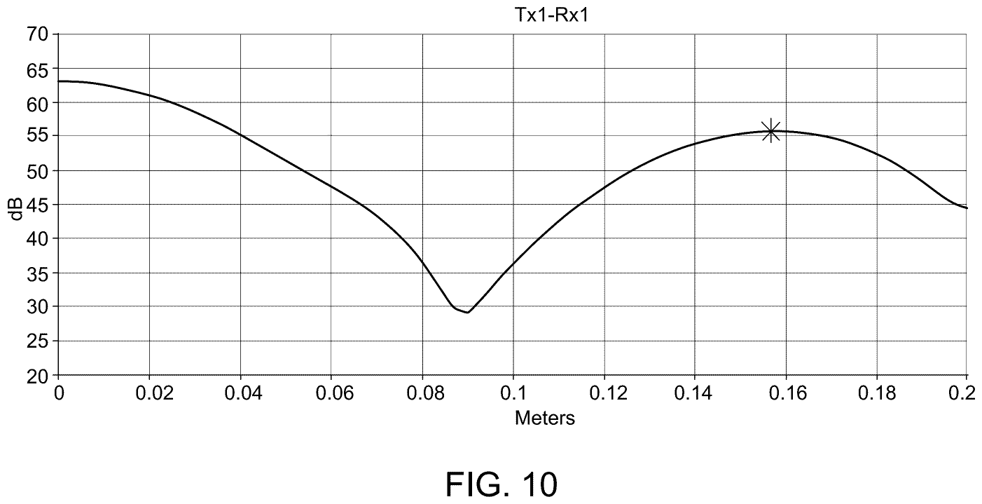

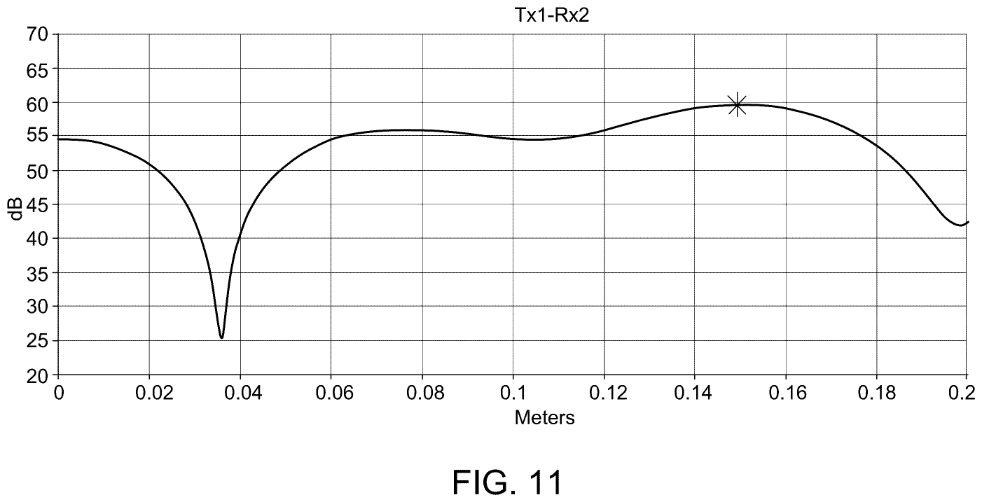

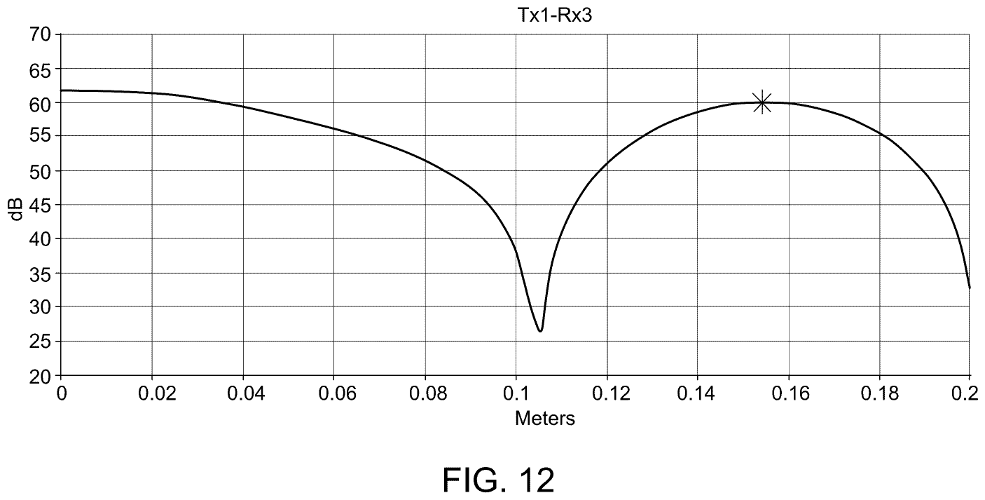

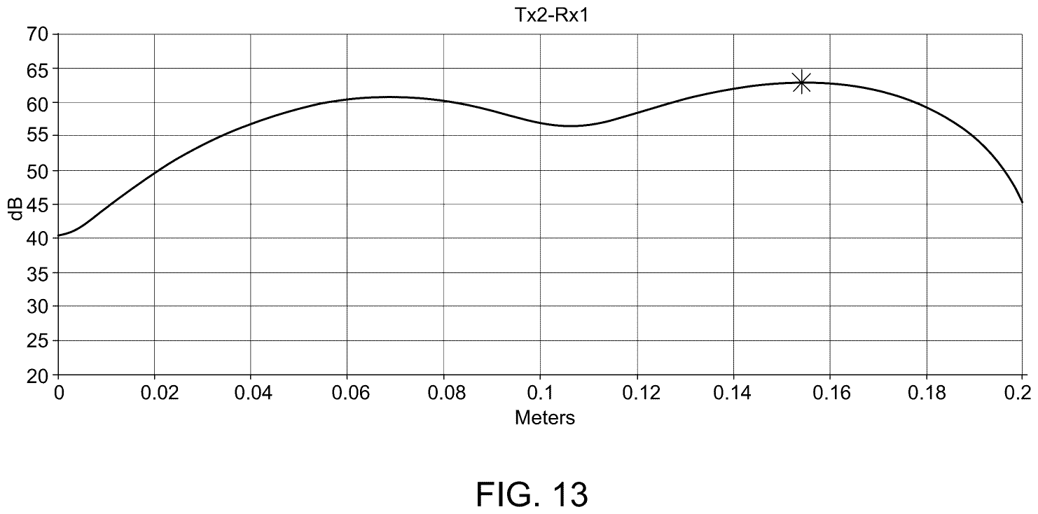

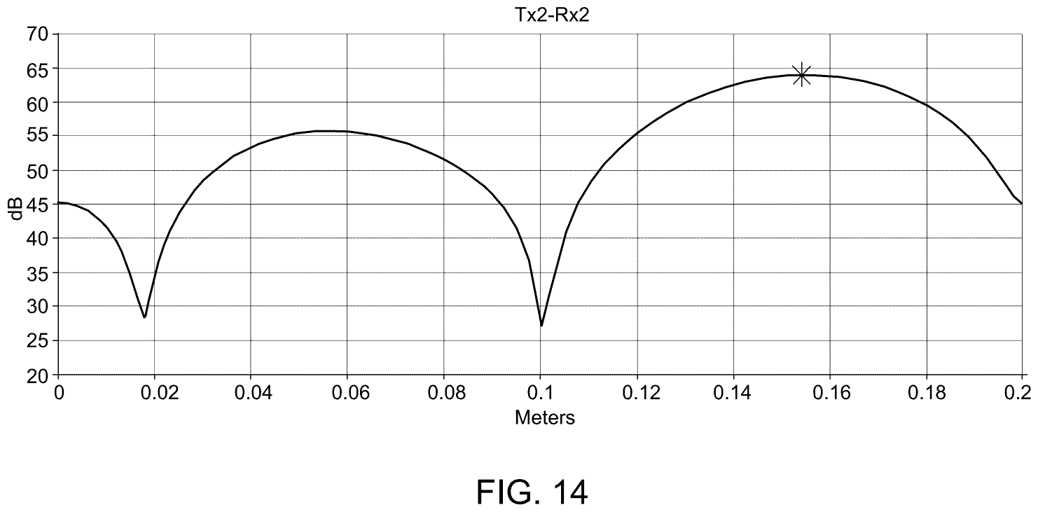

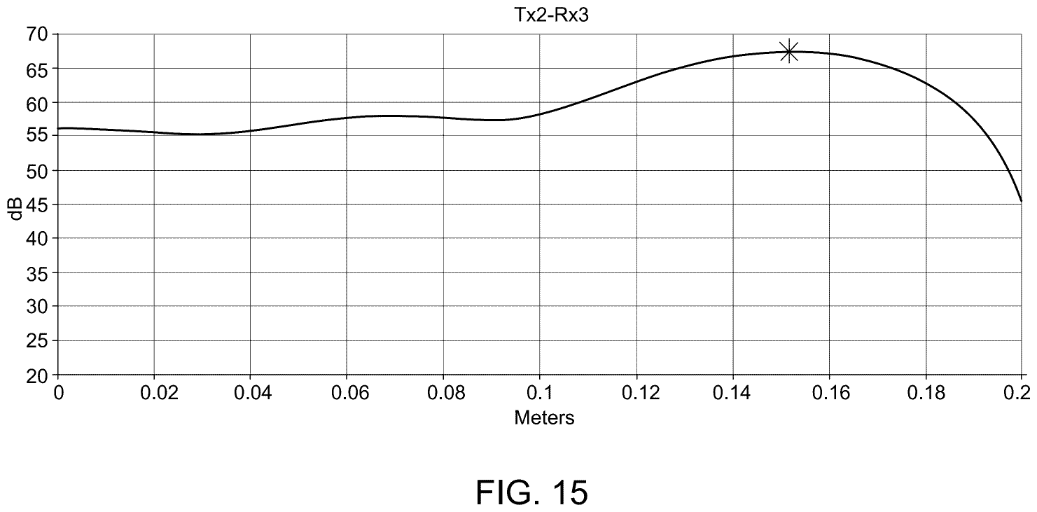

FIGS. 10-15 illustrate radar return power as a function of range which is calculated by converting the FMCW radar signals to the frequency domain. The plots in FIGS. 10-15 correspond to the liquid level measurements illustrated in FIGS. 7-9, wherein FIG. 10 is a radar power plot for the transmitter/receiver pair Tx1 and Rx1; FIG. 11 is a radar power plot for the transmitter/receiver pair Tx1 and Rx2; FIG. 12 is a radar power plot for the transmitter/receiver pair Tx1 and Rx3; FIG. 13 is a radar power plot for the transmitter/receiver pair Tx2 and Rx1; FIG. 14 is a radar power plot for the transmitter/receiver pair Tx2 and Rx2; and FIG. 15 is radar power plot for the transmitter/receiver pair Tx2 and Rx3.

A cursory review of the power plots shown in FIGS. 10-15 confirms the discussion above that the radar return obtained is sensitive to locations of the transmitters and receivers, and as such the six transmitter/receiver pairs return clearly different measurements that are explained by different near return effects at the particular locations of the receivers Rx1, Rx2, and Rx3 for each of the signal transmissions of Tx1 and Tx2. Algorithmic signal processing operations for the power plots to realize the desired combined output 160 (FIG. 7) may include the following.

As shown in each of FIGS. 10-15, the local maximum in radar return power as a function of range within the range of potential water levels for each transmitter/receiver pair may be determined. It is seen from the power plots that below about 0.1 meters the radar returns vary widely amongst the six measurements made from the respective transmitter/receiver pairs. This indicates different near range returns (or an absence of near range returns) in the different power plots and accordingly some of the radar power plots affected by near range returns may not be as reliable. In ranges beyond about 0.1 m, however, each of the six plots appear to converge within a relatively small band of values, and this convergence indicates a range of potential liquid levels that is likely to include the actual liquid level. The local maxima in this range are indicated with stars in FIGS. 10-15, with the corresponding power level at each local maximum and the range at which this local maximum occurs (the “position”) for each transmitter/receiver pair provided below in Table 1.

TABLE 1
Local Maximum and Power Level

| | Tx1 | Tx2 |
|---|---|---|
| Rx1 | Power Level: 55.6 dB | Power Level: 62.9 dB |
| | Position: 0.156 meters | Position: 0.154 meters |
| Rx2 | Power Level: 59.6 dB | Power Level: 64.0 dB |
| | Position: 0.149 meters | Position: 0.154 meters |
| Rx3 | Power Level: 60.0 dB | Power Level: 67.3 dB |
| | Position: 0.154 meters | Position: 0.152 meters |

For the purposes of the combined output 160, the six position values in Table 1 may be averaged. The averaged position of all of the tabulated transmitter/receiver pairs is 0.153 m so the combined output 160 returns a value of 0.153 m. This means that the surface 116 of the liquid inside the tank 100 is 0.153 m (6.02 inches) below the elevation of the radar transmitters and receivers above the top wall 102 of the storage tank 100, which can now be easily converted to a percentage of the tank capacity (i.e., x percent full or y percent empty) as desired.

For purposes of the operation of averaging measurements from transmitter/receiver pairs that have low near range returns to produce the combined output 160, the range of 0.09 m will be used as the range at which the near range returns are evaluated in comparison to a specified threshold. The power levels at range 0.09 m for each of the six transmitter/receiver pairs in the example power plots illustrated in FIGS. 10-15 are tabulated below in Table 2.

TABLE 2
Power Level at 0.09 meters

| | Tx1 | Tx2 |
|---|---|---|
| Rx1 | Power Level: 28 dB | Power Level: 58 dB |
| Rx2 | Power Level: 55 dB | Power Level: 47 dB |
| Rx3 | Power Level: 47 dB | Power Level: 57 dB |

The average power level of all six transmitter/receiver pairs, 48.7 dB, will be used as the specified threshold. It is seen that the power levels at the specified range of the Tx1 and Rx1, Tx1 and Rx3, and Tx2 and Rx2 transmitter/receiver pairs are below the specified threshold and are therefore deemed “low” near range returns. The remaining three power levels for the other three transmitter/receiver pairs in Table 2 are above the average power level and are therefore deemed “high” near range returns. The measurements from the transmitter/receiver pairs with high near range returns are accordingly excluded from the operation of averaging the measurements from transmitter/receiver pairs with low near range returns. As such, the position values in Table 1 for only the transmitter/receiver pairs with low near range returns, as shown in Table 2, are averaged. The average position obtained from the radar returns from these three transmitter/receiver pairs is 0.155 m (6.10 inches). So, the combined output 160 returns a value of 0.155 m.

Averaging measurements in an expected range for the six position values in Table 1 is as follows for purposes of the combined output 160. None of the position values is clearly disparate from the others by a sufficient amount to exclude it as an unreasonable or unexpected value. The difference between the highest position value (0.156 m for the Tx1-Rx1 pair) and the lowest position value (0.149 m for the Tx1-Rx2 pair) is 0.007 m (0.28 inches). This is a good result and none of the measured values of the transmitter/receiver pairs need be excluded. The average of the six position values is again 0.153 m (6.02 inches), so the combined output 160 returns a liquid level value of 0.153 m.

Selecting only the measurement with the lowest near range return for purposes of the combined output 160 is as follows. Referring to Table 2, the Tx1-Rx1 pair has the lowest return at a position of about 0.09 m. The local maximum position (0.156 m) for the Tx1-Rx1 pair is therefore selected for purposes of the combined output 160, so the combined output 160 returns a liquid level value of 0.156 m.

Selecting the measurement closest to an expected range for purposes of the combined output 160 is as follows. Based on prior measurements and/or on water usage data over time, the processor-based device returns an expected measurement of 0.152 m as a baseline to which the transmitter/receiver pair measurements are compared. It is seen from Table 1 that the Tx2-Rx3 pair has a local maximum return at a position of 0.152 m (5.98 inches) in the potential range of values for actual liquid level. The Tx2-Rx3 measurement is therefore selected and the combined output 160 returns a liquid level value of 0.152 m.

The astute reader will note that the different types of processing described above upon the transmitter/receiver pair power outputs for purposes of the combined output 160 returns a set of values from 0.152 m to 0.156 m despite the fact that the Tx1-Rx2 pair indicates a 0.149 m liquid level. In the exemplary set of transmitter/receiver pair liquid level measurements in Table 1, the Tx1-Rx2 pair is the most affected by localized conditions that produce signal error and therefore is the least accurate value, and each of the techniques above reduces, if not entirely eliminates, the influence of the Tx1-Rx2 pair in the combined output 160.

While exemplary types of algorithmic operations are described above to produce a combined output based on the returns of the various transmitter/receiver pairs provided, variations are of course possible and other transmitter and receiver combinations and other algorithmic operations could be implemented to realize otherwise similar advantageous effects. Additionally, one of skill in the art will recognize that similar techniques can be used with a radar sensor that has multiple transmitters and a single receiver (multiple-input single-output or MISO) and a radar sensor that has a single transmitter and multiple receivers (single-input multiple-output or SIMO). In such implementations, the radar sensor arrangements would have different numbers of transmitters and receivers but the algorithms used to produce the desired results would be similar.

Specifically, the above exemplary MIMO radar sensor arrangement described above has two transmitters and three receivers. A MISO sensor arrangement could also be realized by omitting two of the three receivers of the MIMO sensor arrangement (resulting in two transmitters and a single receiver), while a SIMO sensor arrangement could be realized by omitting one of the two transmitters of the MIMO sensor arrangement (resulting in a single transmitter with three receivers). In these examples, the MIMO embodiment would generate six radar returns while the MISO and SIMO arrangements would respectively generate two and three radar returns. However, in all embodiments, the radar returns would be similarly processed to determine the single liquid level output. Of course, three MISO sensor arrangements or two SIMO sensor arrangements could be utilized to generate six radar returns if desired. Combinations of MIMO, MISO and SIMO sensor arrangements are likewise possible to reliably detect liquid levels for the same or different liquid storage tanks.

In yet another contemplated sensor arrangement, a single radar transmitter and a single radar receiver may be connected to a plurality of antennas to obtain a plurality of radar returns with different localized effects that could be combined into a single liquid level detection output with similar algorithmic processing to that described above. More than one such sensor arrangement could be provided on the same or different liquid storage tank, as well as in combination with MIMO, MISO and SIMO arrangements described above.

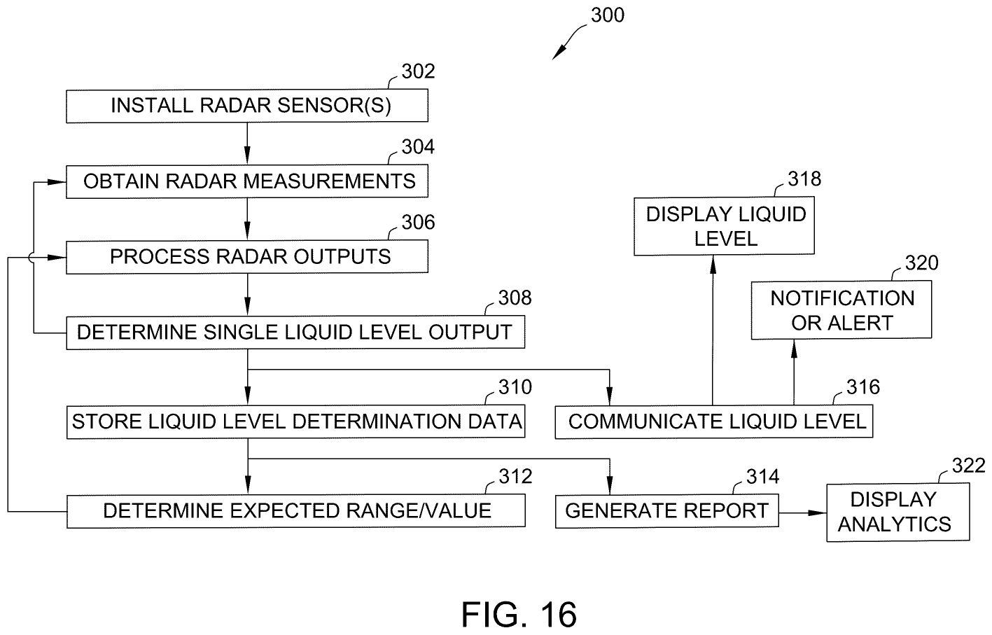

FIG. 16 illustrates exemplary method process 300 of determining liquid level in a storage tank such as the storage tank 100 utilizing the radar sensor systems and implementations of FIGS. 3-9 and operating upon radar transmitter/receiver pair power outputs such as those illustrated in FIGS. 10-15.

As a preparatory step 302, the radar sensors with their respective transmitters and receivers are installed in distributed locations upon a liquid storage tank to be monitored.

For purposes of step 302, the storage tank may be the storage tank 100 described above in relation to FIG. 1, although the benefits of the inventive method do not necessarily depend on the storage tank 100 and instead could be applied to other types of liquid storage tanks. The radar sensors may correspond to any of the sensor arrangements described above (e.g., monostatic radar sensors, bistatic radar sensors, multiple-input multiple-output (MIMO) radar sensors, etc.) with transmitters and receivers that are distributed across and operating upon various different locations on the exterior top wall of the storage tank 100 as described above. Such a distribution of radar transmitters and receivers at various different locations with respect to the storage tank reduces measurement errors due to localized effects that produce returned radar signal variation in the operation of one or more of the transmitters and/or receivers which could otherwise lead to inaccurate liquid level measurement.

In some embodiments the separation between transmitters and/or receivers may simply be on the order of the size of the antennas. For example, the separation may only be about 0.1 in (0.25 cm). Even this small separation in transmitters and/or receivers is effective in achieving improved performance since the size of water droplets or the size of accumulated solids in the storage tank are also small.

Installation of the radar sensors for purposes of step 302 may including mounting the radar sensors in a fixed position to the top wall of the storage tank in any suitable manner, including but not necessarily limited to bonding of the sensors to a surface of the top wall with an adhesive in solid or liquid form, such that the radar transmitters and receivers are operative to transmit and receive radar signals through the top wall without requiring openings to facilitate radar transmissions.

Alternatively, however, in some cases step 302 could include forming openings in the storage tank and aligning the radar transmitters and receivers with the openings to facilitate radar signal transmission through such openings. Such openings could in some cases be preformed in the storage tank. Any openings in the storage tank would of course need to be appropriately sealed as an aspect of sensor installation.

In other contemplated embodiments, the radar sensors may be mechanically mounted in spaced relation from the exterior top wall of the tank, without necessarily being in surface contact with the storage tank as desired. In still other possible embodiments, radar sensors may be mounted on an interior surface of the top wall of the tank provided that they are properly sealed and protected.

Also for the purposes of step 302 the sensors are interfaced with other liquid level detection system components such as the processor-based device 150, as well as other devices receiving the combined output 160 from the processor-based device 150. The sensors, processor-devices, and other devices may communicate via wired or wireless communication paths utilizing predetermined communication protocols.

At step 304, the radar sensors and associated transmitters and receivers are operated to produce multiple radar return measurements made by different transmitter/receiver pairs or transmitter/receiver combinations. Radar returns such as those illustrated in graphical form in FIGS. 10-15 may be generated. The radar returns are collectively input to a separate processor-based device 150 (FIGS. 3-7) in exemplary embodiments to assess the measurement made by the transmitter/receiver combinations relative to one another.

At step 306 the radar returns are processed in the manner described above in relation to, for example, FIGS. 4-9 and the example returns of FIGS. 10-15 to process and produce the combined, single liquid level output at step 308. The processing for step 308 may be made by the processor-based device 150 that receives the respective radar returns and applies one or more of the techniques described above to mitigate the influences of localized conditions that render one or more of the measurements from the transmitter/receiver combinations to be less accurate. The determined, single liquid level output at step 308 corresponds to the output 160 in FIGS. 3-7.

Once the single liquid level output is determined at step 308, the system returns to step 304 and obtains further radar measurements. The system and method is therefore iteratively operable to successively obtain and process radar measurements to determine a sequence of single liquid level outputs over time. With each iteration, the determined single output may be stored at step 310 with any supporting data desired. The stored data from step 310 may be analyzed and used to determine expected ranges of liquid level or expected values of liquid level at step 312 that may serve as baselines to evaluate the data sets at step 306. Steps 310 and 312 provide intelligence regarding liquid usage and corresponding depletion or filling of the storage tank being monitored that may provide a degree of machine learning to become more accurate over time based on actual, historical usage of liquid and patterns of liquid usage that may provide for more meaningful assessment of the data sets at step 306.

Detailed report generation at step 314 is also possible including logged and archived data for review and study of sensor system operation and liquid usage. Such data and report generation may provide insight for a more proactive management of liquid usage as well as to further refine, diagnose or troubleshoot the radar sensor system in view of the data collected. For purposes of report generation at step 314, such reports could be displayed in summary analytic form as shown at step 322 to an interested person on a display screen at any desired location aboard an RV, food truck, or recreational boat, for example. Such report generation may likewise entail printed reports and more detailed data outputs which may be analyzed on another device in further and/or alternative embodiments for system diagnostics and troubleshooting, for liquid usage study and management, or for any other suitable purpose.

As also shown in FIG. 16, as each single liquid level output is determined at step 308, the liquid level output is communicated in a wired or wireless manner to another device where it can be displayed at a convenient location for the benefit of an end user at step 318. Such display may be made via a video monitor or other display screen that may also display a variety of information other than liquid level which may pertain to other aspects of a vehicle system or other system that includes the storage tank being monitored. The display screen in some embodiments may be a touch-sensitive display screen that is located remotely from the storage tank. Such touch-sensitive display may be mounted at a fixed location in a vehicle, or in other cases may be associated with a user device such as a smartphone or tablet computer of the interested owner/operator of the system including the monitored storage device. As such, the display for purposes at step 318 may correspond to different devices having different display screens for access by the same or different persons.

As shown at step 320, notifications or alerts may also be generated based on the value of the last determined liquid level output at step 308. The alerts or notifications can include audio, visual and/or tactile components to garner attention of interested persons who may take appropriate actions in response. The notifications and alerts may be made via different devices at different locations, and such notifications and alerts may be escalated as the liquid level output at step 308 corresponds to critical levels indicating a nearly depleted tank or a nearly full tank that could render the associated system (e.g., a vehicle system) inoperable in a key aspect due to an empty tank or full tank. Data concerning notifications and alerts generated at step 320 could be logged and archived with supporting data and included in report generation at step 314 for further review and study to evaluate the effectiveness of the system.

Having described devices and applicable operating algorithms functionally per the description above, those in the art may accordingly implement suitable algorithms via programming of the processor-based computing devices. Such programming or implementation of the concepts described is believed to be within the purview of those in the art and will not be described further.

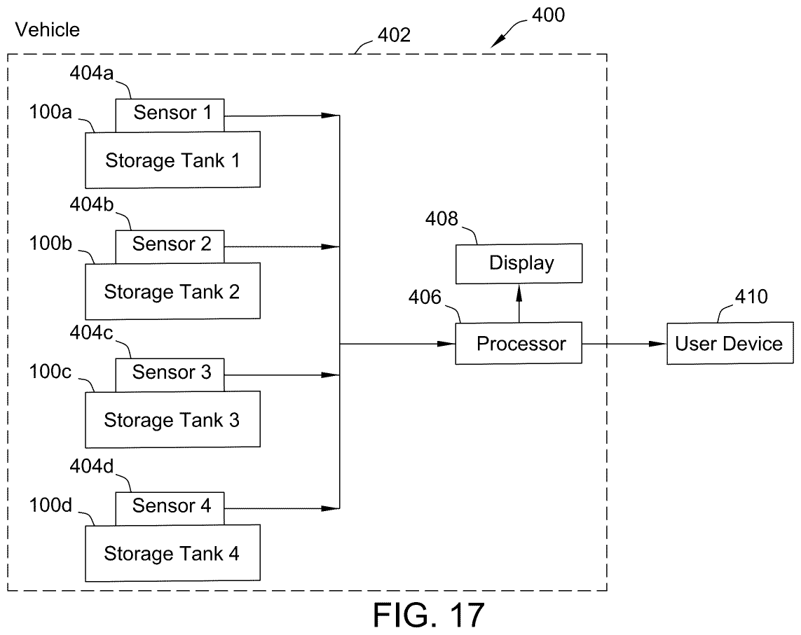

FIG. 17 schematically illustrates a radar sensor liquid level detection system 400 in accordance with an exemplary embodiment of the present invention.

The sensor system 400 is applied to a vehicle 402 including multiple storage tanks 100a, 100b, 100c, and 100d. The storage tank 100a may be a freshwater tank supplying water to one or more locations in the vehicle system. More than one freshwater tank may be provided at the same or different locations in the vehicle 402. The storage tank 100b may be a grey water tank which collects water used in, for example, a lavatory sink or shower in the vehicle 402. The storage tank 100c may be a galley tank which is a specific grey water tank which collects water from a kitchen sink or a kitchen appliance in the vehicle 402. The storage tank 100d may be a black water tank which collects water including human waste from toilet flushing. More than one grey water, and/or black water storage tank may be provided at the same or different locations in the vehicle 402, and still other liquid storage tanks may be included in the vehicle 402 that do not relate to water use, including but not limited to fuel tanks including gasoline, diesel fuel or propane as non-limiting examples of liquid that could also benefit from the radar monitoring systems described. The vehicle 402 in contemplated embodiments may be a recreational vehicle (RV), a food truck, a recreational marine vehicle or boat, or a semi-truck including living quarters for a driver.

Each tank 100a, 100b, 100c, and 100d is respectively equipped with radar sensor systems 404a, 404b, 404c, and 404d that each include transmitters and receivers as described above in relation to FIGS. 3-9 to provide multiple radar-based liquid level measurements for each tank. The radar returns for a combination of measurements made for each tank are input to a centralized processor device 406. The centralized processor device 406 implements the pertinent steps of the method 300 upon the radar returns for each corresponding tank to determine a single liquid level output for each respective tank in a manner that improves accuracy per the description above. Once determined, the single liquid level output for each tank can be communicated and displayed on a central control display 408 in a cabinet having a prominent location and visibility in the vehicle 402. The display 408 in some cases may also include a dashboard display or infotainment display for the vehicle that may be observed by a driver of the vehicle while the vehicle is in transit.

The single liquid level outputs for each monitored tank in the vehicle 402 may also be sent to or retrievable from user devices 410 such as smartphones for users that may not be in the vehicle, tablet computer devices that may be present in the vehicle, laptop or notebook computers, or desktop computers as preferred by interested users. Notifications, alerts and alarms may be generated via any of the devices described to command attention of users inside or outside of the vehicle of important liquid level detection events once the emptiness or fullness of the tanks crosses predetermined thresholds.

The system 400 is generally scalable to a number n of storage tanks 100 storing or collecting different liquids in the vehicle which may be monitored simultaneously with improved accuracy. While illustrated and described in relation to a vehicle 402, the benefits of simultaneous monitoring of multiple tanks with a single processor 406 and reported on a centrally located display 408 or vis user devices 410 is not necessarily limited to vehicle use.

The sensor systems and processes described are implemented with processor-based devices that each include a controller such as a microprocessor and a memory storage wherein executable instructions, commands, and control algorithms, are stored, as well as other data and information required to satisfactorily operate the pertinent devices in the systems and to perform aspects of the methods described herein. The memory of the processor-based devices may be, for example, a random access memory (RAM), and other forms of memory used in conjunction with RAM memory, including but not limited to flash memory (FLASH), programmable read only memory (PROM), and electronically erasable programmable read only memory (EEPROM) may likewise be included.

One or more computer-readable storage media may include computer-executable instructions embodied thereon for interfacing with the pertinent processor-based devices described. When executed by the processor in each respective device the computer-executable instructions may cause the processor to perform one or more algorithmic steps of a method such as the method described and illustrated in the example of FIG. 16. As such, the processor in the radar sensors may operate the radar transmitters and receivers and obtain the multiple radar returns to measure the liquid level in the storage tank. Likewise, the processor in the device 150 described above may perform the assessment of the radar returns for each tank being monitored to provide the single output 160 with improved accuracy. It is recognized, however, that the functionality by the different processors may be combined in the systems and methods described. For example, the processor of a radar sensor may assess the radar returns to produce a liquid level measurement for each transmitter/receiver combination, and another processor-based device may produce the single, combined output.

The above-described embodiments of the disclosure may be implemented using computer programming or engineering techniques including computer software, firmware, hardware or any combination or subset thereof, wherein the technical effects described above are achieved. Any such resulting program, having computer-readable code means, may be embodied or provided within one or more computer-readable media, thereby making a computer program product, (i.e., an article of manufacture), according to the embodiments described above. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

Such computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

The applications described above are flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described. Each component and process can also be used in combination with other assembly packages and processes.

The benefits of the inventive concepts are now believed to have been amply illustrated in relation to the exemplary embodiments disclosed.

An embodiment of a liquid level sensor system for a liquid storage tank has been disclosed. The system includes at least one sensor having: a plurality of radar transmitters and one or more radar receivers, wherein an antenna associated with each of the plurality of radar transmitters is at a respectively unique location relative to the liquid storage tank; and at least one processor configured to determine, in view of the respective radar returns from combinations of the plurality of radar transmitters and one or more receivers, a single liquid level output for the liquid storage tank.

Optionally, the one or more processors may be a single processor. A liquid level measurement may be determined for each combination of a transmitter and receiver via angular processing of the radar return.

The plurality of radar transmitters and one or more radar receivers may optionally include a plurality of radar transmitters and a single radar receiver defining a multiple-input, single-output radar sensor arrangement. The plurality of radar transmitters may be respectively operable at different times to obtain a plurality of liquid level measurements. Alternatively, the plurality of radar transmitters and one or more radar receivers may define a multiple-input multiple-output radar sensor arrangement, wherein the plurality of radar transmitters are respectively operable with the common plurality of receivers at different times to obtain a plurality of liquid level measurements.

The at least one processor may be integrally provided with the at least one sensor. The at least one processor may also include a first processor and a second processor at respectively different locations. The at least one processor may be configured to: generate data as a function of distance from each respective radar return; determine from the generated data a local maximum within a range of potential liquid level measurements for each respective radar return; and determine the single liquid level output based upon the determined local maxima of the radar returns. The at least one processor may also be configured to: determine a position value corresponding to each of the determined local maxima in the radar returns; and average the determined position values to determine the single liquid level output.

The at least one processor may be configured to: compare a near-range return in each radar return to a predetermined power threshold; and determine the single liquid level output by averaging liquid level measurements only from ones of the radar returns with a near-range return that is below the predetermined power threshold.

The at least one processor may be configured to: determine whether a liquid level measurement from each of the radar returns is within an expected range; and average the liquid level measurements from only the liquid level measurements that are within the expected range to determine the single liquid level output.

The at least one processor may be configured to: generate near range return and corresponding position data for each of the radar returns; and select the position data corresponding to the lowest of the near-range returns to determine the single liquid level output.

The at least one processor may be configured to: determine an expected liquid level measurement; and determine a liquid level measurement from the radar sensors that is closest to the expected liquid level measurement to determine the single liquid level output.

The system may optionally be provided in combination with the liquid storage tank, and the respectively unique locations may be exterior to the liquid storage tank. The plurality of radar transmitters and one or more radar receivers may transmit or receive through a common exterior wall of the liquid storage tank. The plurality of radar transmitters and one or more radar receivers may be fixedly mounted at a predetermined distance from the exterior common wall, and may be mounted to the common exterior wall.

The liquid storage tank may be a low-profile storage tank, may be a low-capacity storage tank, and may be a mobile storage tank. The mobile storage tank may be included in a recreational vehicle, a recreational boat, a food truck, or a semi-truck equipped with living quarters. The liquid storage tank may be a water tank. The water tank may be a grey or black water storage tank.

The system may include at least one display, wherein a fullness or emptiness status of the liquid storage tank, based upon the last determined single liquid level output, is visually presented on the at least one display. The at least one display may be a touch sensitive display. A liquid level alert or notification, based on a last determined single liquid level output, may be visually presented on the at least one display. The at least one display may be a central control display for a vehicle system. The display may alternatively be associated with a user device, the user device being selected from the group of a smartphone, a tablet computer device, a laptop computer device, a notebook computer device or a desktop computer device.

The system may optionally be configured to make the single liquid level output retrievable from a user device. The user device may be a smartphone, a tablet computer device, or a laptop or notebook computer device.

The system may optionally include a centralized processor device in communication with the at least one display, the centralized processor device receiving a single liquid level output for each of a plurality of liquid storage tanks, wherein each of the plurality of liquid storage tanks are associated with a plurality of independently operable radar transmitters and receivers to measure the liquid level therein. The centralized processor may be configured to: determine the single liquid level output for each respective one of a plurality of liquid storage tanks respectively associated with a plurality of independently operable radar sensors to measure the liquid level therein; and report the respective single liquid level output for all of the plurality of liquid storage tanks via the at least one display.

The liquid storage tank may be subject to solid or liquid buildup inside of the liquid storage tank, the solid or liquid buildup producing transient localized effects in liquid level measurements with the plurality of independently operable radar sensors. The liquid storage tank may be a grey water tank or a black water tank in a vehicle. The vehicle may be a recreational vehicle.

The liquid storage tank may have an uneven wall thickness, the uneven wall thickness producing localized effects in the radar returns. The liquid storage tank may be a water tank which supplies freshwater or collects non-potable water inside a recreational vehicle, a recreational boat, a food truck, or a semi-truck equipped with living quarters.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A liquid level sensor system for a liquid storage tank, the system comprising:
at least one sensor comprising:
a plurality of radar transmitters and one or more radar receivers, wherein an antenna associated with each of the plurality of radar transmitters is at a respectively unique location relative to the liquid storage tank; and
at least one processor configured to determine, in view of the respective radar returns from combinations of the plurality of radar transmitters and one or more receivers, a single liquid level output for the liquid storage tank.

2. The system of claim 1, wherein the one or more processors is a single processor.

3. The system of claim 1, wherein a liquid level measurement is determined for each combination of a transmitter and receiver via angular processing of the radar return.

4. The system of claim 1, wherein the plurality of radar transmitters and one or more radar receivers comprises a plurality of radar transmitters and a single radar receiver defining a multiple-input, single-output radar sensor arrangement.

5. The system of claim 4, wherein the plurality of radar transmitters are respectively operable at different times to obtain a plurality of liquid level measurements.

6. The system of claim 1, wherein the plurality of radar transmitters and one or more radar receivers define a multiple-input multiple-output radar sensor arrangement.

7. The system of claim 6, wherein the plurality of radar transmitters are respectively operable with the common plurality of receivers at different times to obtain a plurality of liquid level measurements.

8. The system of claim 1, wherein the at least one processor is integrally provided with the at least one sensor.

9. The system of claim 1, wherein the at least one processor comprises a first processor and a second processor at respectively different locations.

10. The system of claim 1, wherein the at least one processor is configured to:
generate data as a function of distance from each respective radar return;
determine from the generated data a local maximum within a range of potential liquid level measurements for each respective radar return; and
determine the single liquid level output based upon the determined local maxima of the radar returns.

11. The system of claim 10, wherein the at least one processor is further configured to:
determine a position value corresponding to each of the determined local maxima in the radar returns; and
average the determined position values to determine the single liquid level output.

12. The system of claim 1, wherein the at least one processor is configured to:
compare a near-range return in each radar return to a predetermined power threshold; and
determine the single liquid level output by averaging liquid level measurements only from ones of the radar returns with a near-range return that is below the predetermined power threshold.

13. The system of claim 1, wherein the at least one processor is configured to:
determine whether a liquid level measurement from each of the radar returns is within an expected range; and
average the liquid level measurements from only the liquid level measurements that are within the expected range to determine the single liquid level output.

14. The system of claim 1, wherein the at least one processor is configured to:
generate near range return and corresponding position data for each of the radar returns; and
select the position data corresponding to the lowest of the near-range returns to determine the single liquid level output.

15. The system of claim 14, wherein the at least one processor is configured to:
determine an expected liquid level measurement; and
determine a liquid level measurement from the radar sensors that is closest to the expected liquid level measurement to determine the single liquid level output.

16. The system of claim 1, in combination with the liquid storage tank.

17. The system of claim 16, wherein the respectively unique locations are exterior to the liquid storage tank.

18. The system of claim 17, wherein the plurality of radar transmitters and one or more radar receivers transmit or receive through a common exterior wall of the liquid storage tank.

19. The system of claim 18, wherein the plurality of radar transmitters and one or more radar receivers are fixedly mounted at a predetermined distance from the exterior common wall.

20. The system of claim 19, wherein the plurality of radar transmitters and one or more radar receivers are mounted to the common exterior wall.

21. The system of claim 16, wherein the liquid storage tank is a low-profile storage tank.

22. The system of claim 21, wherein the liquid storage tank is a low-capacity storage tank.

23. The system of claim 22, wherein the liquid storage tank is a mobile storage tank.

24. The system of claim 23, wherein the mobile storage tank is included in a recreational vehicle, a recreational boat, a food truck, or a semi-truck equipped with living quarters.

25. The system of claim 23, wherein the liquid storage tank is a water tank.

26. The system of claim 23, wherein the water tank is a grey or black water storage tank.

27. The system of claim 1, further comprising at least one display, wherein a fullness or emptiness status of the liquid storage tank, based upon the last determined single liquid level output, is visually presented on the at least one display.

28. The system of claim 27, wherein the at least one display is a touch sensitive display.

29. The system of claim 27, wherein a liquid level alert or notification, based on a last determined single liquid level output, is visually presented on the at least one display.

30. The system of claim 27, wherein the at least one display is a central control display for a vehicle system.

31. The system of claim 27, wherein the display is associated with a user device, the user device being selected from the group of a smartphone, a tablet computer device, a laptop computer device, a notebook computer device or a desktop computer device.

32. The system of claim 1, wherein the system is further configured to make the single liquid level output retrievable from a user device.

33. The system of claim 32, wherein the user device is a smartphone, a tablet computer device, or a laptop or notebook computer device.

34. The system of claim 27, further comprising a centralized processor device in communication with the at least one display, the centralized processor device receiving a single liquid level output for each of a plurality of liquid storage tanks, wherein each of the plurality of liquid storage tanks are associated with a plurality of independently operable radar transmitters and receivers to measure the liquid level therein.

35. The system of claim 27, wherein the processor is a centralized processor in communication with the at least one display, the centralized processor configured to:
determine the single liquid level output for each respective one of a plurality of liquid storage tanks respectively associated with a plurality of independently operable radar sensors to measure the liquid level therein; and
report the respective single liquid level output for all of the plurality of liquid storage tanks via the at least one display.

36. The system of claim 1, wherein the liquid storage tank is subject to solid or liquid buildup inside of the liquid storage tank, the solid or liquid buildup producing transient localized effects in liquid level measurements with the plurality of independently operable radar sensors.

37. The system of claim 36, wherein the liquid storage tank is a grey water tank or a black water tank in a vehicle.

38. The system of claim 37, wherein the vehicle is a recreational vehicle.

39. The system of claim 1, wherein the liquid storage tank has an uneven wall thickness, the uneven wall thickness producing localized effects in the radar returns.

40. The system of claim 39, wherein the liquid storage tank is a water tank.

41. The system of claim 40, wherein the water tank supplies freshwater or collects non-potable water inside a recreational vehicle, a recreational boat, a food truck, or a semi-truck equipped with living quarters.
